(19) United States
(12) Patent Application Publication
(10) Pub. No.: US 2026/0220780 A1
(43) Pub. Date: Jul. 30, 2026

(54) NON-INVASIVE EUPLOIDY PREDICTION METHOD AND SYSTEM

(71) Applicant: SUZHOU BOUNDLESS MEDICAL TECHNOLOGY CO., LTD., Suzhou (CN)

(72) Inventors: Chunfeng YUE, Suzhou (CN); Guanqiao SHAN, Suzhou (CN); Zongjie HUANG, Suzhou (CN); Miao HAO, Suzhou (CN)

(21) Appl. No.: 19/574,780

(22) Filed: Mar. 23, 2026

Related U.S. Application Data
(63) Continuation of application No. PCT/CN2023/132491, filed on Nov. 20, 2023.

(30) Foreign Application Priority Data
Oct. 9, 2023 (CN) 202311299432.2

(51) Int. Cl. G06T 7/00; G01N 1/30; G06T 7/62; G06V 10/774; G06V 10/776; G06V 20/69

(52) U.S. Cl. CPC G06T 7/0012; G01N 1/30; G06T 7/62; G06V 10/774; G06V 10/776; G06V 20/693; G06T 2207/30024; G06T 2207/30044; G06T 2207/30242

(57) ABSTRACT

The application provides a non-invasive euploidy prediction method and system. The method includes: acquiring target parameters of a blastocyst including a blastocyst diameter, a trophectoderm (TE) cell quantity, a TE cell density, a standard deviation of the TE cell areas, and an inner cell mass (ICM) area of the blastocyst to be predicted; and inputting the target parameters into a target decision tree euploidy prediction model, and determining, according to the target parameters of the blastocyst to be predicted, whether the blastocyst to be predicted is euploid. The target decision tree euploidy prediction model can acquire the blastocyst diameter, the TE cell quantity, the TE cell density, the standard deviation of the TE cell areas, and the ICM area. By inputting these pieces of data into the target decision tree euploidy prediction model, the prediction of the embryo euploidy is achieved, thereby promoting the selection or classification of embryos.

This application is a Continuation Application of PCT/CN2023/132491, filed on Nov. 20, 2023, which claims priority to Chinese Patent Application No. 202311299432.2, filed on Oct. 9, 2023, which is incorporated by reference for all purposes as if fully set forth herein.

### FIELD OF THE INVENTION

The present application relates to the technical field of biomedical science, and particularly to a non-invasive euploidy prediction method and system.

### DESCRIPTION OF THE RELATED ART

Spheroid cell aggregates, including spheroid bodies, embryoid bodies and embryos, play a vital role in developmental biology and medical treatment. Compared with 2D monolayer cells, the spheroid cell aggregates can more accurately characterize the 3D morphological characteristics of their counterparts in the body. In in-vitro fertilization (IVF) treatment, the embryo morphology assessment is a key step in the clinical selection of an embryo with high reproductive potential to implant the embryo into the patient's uterus. To measure the 3D morphology of the spheroid cell aggregates (such as the total number of cells, the cell density and the size of a single cell), fluorescent markers are usually used, but there is a risk of toxicity and phototoxicity of fluorescent dyes. In these cases, a complete 3D morphology cannot be obtained, and only part of the 2D morphology of the cell aggregates can be evaluated.

Currently, abnormal chromosome number (called aneuploidy) is a major cause of implantation failure or unhealthy pregnancies of in-vitro fertilized embryos. At present, one of the aneuploidy detection methods includes preimplantation genetic testing (PGT) of embryonic cells. Biopsy for PGT can be performed at three different stages of embryonic development. For example, biopsy of polar body from oocytes or fertilized eggs can be performed on day 0 or day 1 after fertilization; embryo biopsy at the cleavage stage can be performed on day 3 after fertilization; and blastocyst biopsy can be performed on day 5 or 6 after fertilization. Because the blastocyst biopsy is to remove multiple trophectoderm (TE) cells from the blastocyst, this technique has little influence on the reproductive potential of embryos and provides more cells for genetic analysis, thus improving the sensitivity and reliability of subsequent genetic testing. Therefore, the blastocyst biopsy performed on day 5 or 6 after fertilization is a technique widely used in PGT in a reproductive center.

Blastocyst (day 5 embryo) is a biological structure formed in the early development of mammals and a typical spheroid cell aggregate. As shown in FIG. 2, the blastocyst contains a fist-shaped cell cluster called inner cell mass (ICM), which is eventually developed into a fetus. The monolayer TE cells in the blastocyst forms a spherical cavity to protect the inner cell mass. The whole blastocyst is protected by a zona pellucida (ZP) composed of specific glycoproteins. At the 2011 International Consensus Conference on Embryo Assessment, the most important morphological parameters for blastocysts are defined to include TE cell quantity, TE cell density, size variance of TE cells and ICM size. Currently, in clinical treatment, the embryologists evaluate these parameters according to a single 2D image or several 2D images captured from different focal planes. This evaluation lacks complete 3D morphological information, and the evaluation result varies with the orientation of the blastocyst. The same blastocyst can show a low TE cell quantity and a small ICM size in some orientations, but a high TE cell quantity and a large ICM size in other orientations, causing arguments and errors in the evaluation results of blastocyst selection and implantation.

The results of chromosome screening of blastocysts by PGT will show whether the embryo is euploid, mosaic, or aneuploid. A healthy embryo has 46 chromosomes and is euploid. However, if the embryo further has one more chromosome or one less chromosome, or even a fragment is deleted or increased, the embryo is aneuploid.

There are differences in morphological development between aneuploid embryos and euploid embryos. Studies show that the morphological indexes of embryos have the potential to be used as a non-invasive evaluation means for chromosome ploidy of embryos. However, PGT, an invasive detection method to remove cells from embryos before implantation, will interfere with the embryo development, and the embryo biopsy requires special equipment and strictly trained professionals, which also requires large time and cost consumption. It can be seen that it is particularly important to develop a non-invasive, efficient, high-precision and simple-to-operate euploidy prediction methods for embryos.

It is to be understood that the information disclosed in the above background section is only used to enhance the understanding of the background of the present disclosure, so it may include information that does not constitute the prior art known to those of ordinary skill in the art.

### SUMMARY OF THE INVENTION

In view of the shortcomings and defects in the prior art, the present application provides a non-invasive euploidy prediction method and system. Five accurate blastocyst parameters including a blastocyst diameter, a TE cell quantity, a TE cell density, a standard deviation of the TE cell areas, and an ICM area are acquired by 3D modeling of the blastocyst. By inputting these pieces of data into a decision tree embryo euploidy prediction model, the prediction of the embryo euploidy is realized, thereby promoting the selection or classification of embryos in conventional IVF-ET cycles.

The present invention provides a non-invasive euploidy prediction method. The method includes:
acquiring target parameters of a blastocyst to be predicted, where the target parameters include a blastocyst diameter, a TE cell quantity, a TE cell density, a standard deviation of the TE cell areas, and an ICM area of the blastocyst to be predicted; and
inputting the target parameters into a target decision tree euploidy prediction model, and determining, according to the target parameters of the blastocyst to be predicted, whether the blastocyst to be predicted is euploid.

In an embodiment of the present invention, the determining, according to the target parameters of the blastocyst to be predicted, whether the blastocyst to be predicted is euploid includes:
when the TE cell quantity of the blastocyst to be predicted is greater than or equal to a first target value, the blastocyst to be predicted is euploid.

In an embodiment of the present invention, when the TE cell quantity of the blastocyst to be predicted is less than the first target value,
if the standard deviation of the TE cell areas of the blastocyst to be predicted is less than or equal to a second target value, and the ICM area of the blastocyst to be predicted is greater than or equal to a third target value, the blastocyst to be predicted is euploid.

In an embodiment of the present invention, before inputting the target parameters into the target decision tree euploidy prediction model, the method further includes:
acquiring a data set, where the data set includes a blastocyst diameter, a TE cell quantity, a TE cell density, a standard deviation of the TE cell areas, and an ICM area of each of multiple blastocysts;
determining label information for each blastocyst in the data set by TE biopsy and PGT-A, to divide the blastocysts into euploid, mosaic, and aneuploid;
collecting, according to the data set and the label information, a first target number of blastocysts, training an initial decision tree euploidy prediction model, and collecting a second target number of blastocysts to form a test data set; and
testing the trained decision tree euploidy prediction model by using the test data set until the accuracy of the test result reaches a preset threshold, so that the training of the decision tree euploidy prediction model is completed, and the target decision tree euploidy prediction model is obtained.

In an embodiment of the present invention, the blastocyst diameter, the TE cell quantity, the TE cell density, the standard deviation of the TE cell areas and the ICM area of each blastocyst in the data set are acquired through the following steps:
fixing a single blastocyst at the center of the visual field by a micromanipulator system, and rotating the blastocyst around different preset centers to capture images at preset angles;
projecting the images on a spherical surface, to form a 3D surface model of the blastocyst; and
determining, from the 3D surface model of the blastocyst, the blastocyst diameter, the TE cell quantity, the TE cell density, the standard deviation of the TE cell areas and the ICM area of the single blastocyst.

In an embodiment of the present invention, the testing the trained decision tree euploidy prediction model by using the test data set comprises: performing univariate analysis and euploidy prediction on the blastocysts in the test data set.

In an embodiment of the present invention, the univariate analysis comprises:
comparing the blastocyst diameters, the TE cell quantities, the TE cell densities, the standard deviations of the TE cell areas and the ICM areas of the euploid and aneuploid blastocysts; and
obtaining target values respectively corresponding to the blastocyst diameter, the TE cell quantity, the TE cell density, the standard deviation of the TE cell areas and the ICM area of the euploid blastocyst according to the comparison results.

In an embodiment of the present invention, the analysis of the euploidy prediction result comprises:
inputting the test data set into the trained decision tree euploidy prediction model; and
determining, according to the TE cell quantity, the standard deviation of the TE cell areas, and the ICM area, whether each blastocyst in the test data set is euploid.

The present invention further provides a non-invasive euploidy prediction system. The system includes:
an acquiring module, configured to acquire target parameters of a blastocyst to be predicted, where the target parameters include a blastocyst diameter, a TE cell quantity, a TE cell density, a standard deviation of the TE cell areas, and an ICM area of the blastocyst to be predicted; and
a prediction module, configured to input the target parameters into a target decision tree euploidy prediction model, and determine, according to the target parameters of the blastocyst to be predicted, whether the blastocyst to be predicted is euploid.

In an embodiment of the present invention, the system further comprises a model training module, configured to
acquire a data set, where the data set includes a blastocyst diameter, a TE cell quantity, a TE cell density, a standard deviation of the TE cell areas, and an ICM area of each of multiple blastocysts;
determine label information for each blastocyst in the data set by TE biopsy and PGT-A, to divide the blastocysts into euploid and aneuploid;
collect, according to the data set and the label information, a first target number of blastocysts, train an initial decision tree euploidy prediction model, and collect a second target number of blastocysts to form a test data set; and
test the trained decision tree euploidy prediction model by using the test data set until the accuracy of the test result reaches a preset threshold, so that the training of the decision tree euploidy prediction model is completed, and the target decision tree euploidy prediction model is obtained.

Compared with the prior art, the technical solution of the present invention has the following advantages:

According to the present invention, through 3D modeling of the blastocyst, the morphology of the blastocyst is measured, and five blastocyst parameters including the blastocyst diameter, the TE cell quantity, the TE cell density, the standard deviation of the TE cell areas, and the ICM area are acquired. Moreover, a measurement method for fine measurement of the blastocyst parameters is constructed by image stitching and U-Net for model segmentation, which provides vital data support for the accuracy of aneuploidy prediction.

The euploidy prediction method provided in the present invention is a non-invasive prediction method, by which the euploidy prediction can be realized only by acquiring the five parameters including the blastocyst diameter, the TE cell quantity, the TE cell density, the standard deviation of the TE cell areas, and the ICM area by 3D modeling of the blastocyst after the decision tree model is trained, and inputting these parameters into the decision tree model.

The blastocyst euploidy prediction model provided in the present invention can automatically predict the blastocyst euploidy without manual intervention in the prediction process. Moreover, the proposed 3D modeling technique of the blastocyst is not limited to the 3D modeling of the blastocyst, but also suitable for the 3D modeling of any spheroid cells and embryos.

In summary, the euploidy prediction method provided in the present invention is not only simple to operate, but also has the characteristics of high efficiency, high accuracy and others.

### BRIEF DESCRIPTION OF THE DRAWINGS

To make the disclosure of the present invention more comprehensible, the present invention will be further described in detail by way of specific embodiments of the present invention with reference the accompanying drawings, in which:

FIG. 1 shows a flow chart of a non-invasive euploidy prediction method provided in an embodiment of the present application.

FIG. 2 shows a flow chart of a process for acquiring a target decision tree euploidy prediction model in the non-invasive euploidy prediction method provided in the embodiment of the present application.

FIG. 3 shows an image of a blastocyst in a middle plane provided in an embodiment of the present application.

FIG. 4 shows an image when each TE cell and ICM in a blastocyst are clearly visible provided in the embodiment of the present application.

FIG. 5 shows a schematic diagram when a blastocyst is gently pushed by using a biopsy micropipette provided in an embodiment of the present application.

FIG. 6 shows another schematic diagram when a blastocyst is gently pushed by using a biopsy micropipette provided in an embodiment of the present application.

FIG. 7 shows a schematic diagram showing image stitching by speeded up robust SIFT (SR-SIFT) algorithm provided in an embodiment of the present application.

FIG. 8 shows a schematic diagram showing a 3D surface model of a blastocyst formed by projecting a multi-view image on a spherical surface Q provided in an embodiment of the present application.

FIG. 9 shows a schematic diagram showing a proportion of abnormal cells in different blastocysts provided in an embodiment of the present application.

FIG. 10 shows a flow chart of rules of quantification by a target decision tree euploidy prediction model provided in an embodiment of the present application.

FIG. 11 shows function modules in a non-invasive euploidy prediction system provided in an embodiment of the present application.

### DETAILED DESCRIPTION OF THE PREFERRED EMBODIMENTS

To make the objects, technical solutions and advantages of the embodiments of the present application clearer, the technical solution according to the embodiments of the present application will be described clearly and fully below with reference to the accompanying drawings in the embodiments of the present application. It is to be understood that the drawings in the present application are for illustrative and descriptive purposes only, and not intended to limit the scope of protection of the present application. Moreover, it is to be understood that the schematic drawings are not drawn to scale. The flowcharts used in the present application show operations implemented according to some embodiments of the present application. It is to be understood that the operations in the flowchart can be implemented randomly, and steps without logical context can be implemented in a reverse order or simultaneously. In addition, those skilled in the art can add one or more other operations to the flow chart or remove one or more operations from the flow chart under the guidance of the disclosure in the present application.

Moreover, the embodiments described are merely some, but not all of the embodiments of the present application. Generally, the components of the embodiments of the present application described and illustrated in the drawings herein can be arranged and designed in various different configurations. Therefore, the following detailed description of the embodiments of the present application provided in connection with the accompanying drawings is not intended to limit the scope of the claimed application, but merely represents selected embodiments of the present application. Based on the embodiments of the present application, all other embodiments obtained by a person of skill in the art without creative efforts shall fall within the protection scope of the present application.

To enable those skilled in the art to practice the disclosure in the present invention, the following embodiments are given in combination with a specific application scenario “Non-invasive euploidy prediction based on 3D modeling of blastocysts”. For those skilled in the art, the general principles defined here can be applied to other embodiments and application scenarios without departing from the spirit and scope of the present application.

The method described below in the embodiment of the present application can be applied to any scenario that requires non-invasive euploidy prediction based on 3D modeling of the blastocyst. The embodiment of the present application does not have particular limitation on specific application scenarios, and any non-invasive euploidy prediction based on 3D modeling of the blastocyst provided in the embodiment of the present application is embraced in the protection scope of the present application.

To facilitate the understanding of the present application, the technical solution of the present disclosure will be described in detail below in combination with specific embodiments.

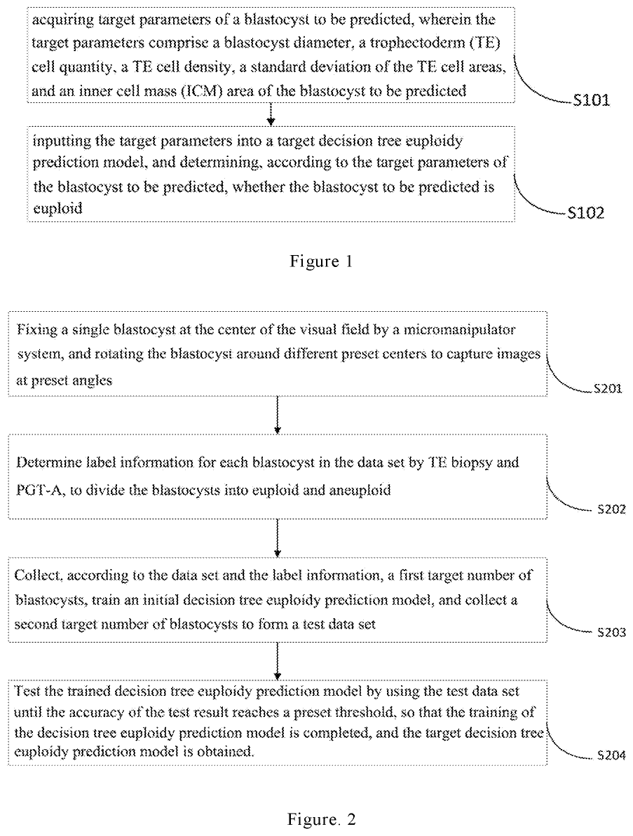

FIG. 1 shows a flow chart of a non-invasive euploidy prediction method provided in an embodiment of the present application. The method provided in the embodiment of the present application includes the following steps:

S101: Acquire target parameters of a blastocyst to be predicted, where the target parameters include a blastocyst diameter, a TE cell quantity, a TE cell density, a standard deviation of the TE cell areas and an ICM area of the blastocyst to be predicted.

FIG. 2 shows a flow chart of a process for acquiring a target decision tree euploidy prediction model in the non-invasive euploidy prediction method provided in the embodiment of the present application. In some possible embodiments, before inputting the target parameters into the target decision tree euploidy prediction model, as shown in FIG. 2, the method further includes:

S201: Acquire a data set; where the data set includes a blastocyst diameter, a TE cell quantity, a TE cell density, a standard deviation of the TE cell areas, and an ICM area of each of multiple blastocysts.

In some possible embodiments, the blastocyst diameter, the TE cell quantity, the TE cell density, the standard deviation of the TE cell areas and the ICM area of each blastocyst in the data set are acquired through the following steps:
fixing a single blastocyst at the center of the visual field by a micromanipulator system, and rotating the blastocyst around different preset centers to capture images at preset angles;
projecting the images on a spherical surface, to form a 3D surface model of the blastocyst; and
determining, from the 3D surface model of the blastocyst, the blastocyst diameter, the TE cell quantity, the TE cell density, the standard deviation of the TE cell areas and the ICM area of the single blastocyst.

Exemplarily, the blastocyst is fixed at the center of the visual field by a conventional micromanipulator system in a reproductive center, and the blastocyst is rotated around different centers to capture a multi-view image (to ensure that the blastocyst is scanned from every perspective) for 3D modeling of the blastocyst. A 3D surface model of the blastocyst is formed on a spherical surface by image projection. Finally, five accurate model input parameters, including the blastocyst diameter, the TE cell quantity, the TE cell density, the standard deviation of the TE cell areas and the ICM area are measured by 3D modeling of the blastocyst.

In a specific embodiment, a multi-view image of a day 6 blastocyst is captured by rotating the blastocyst for 3D modeling of the blastocyst in the present application.

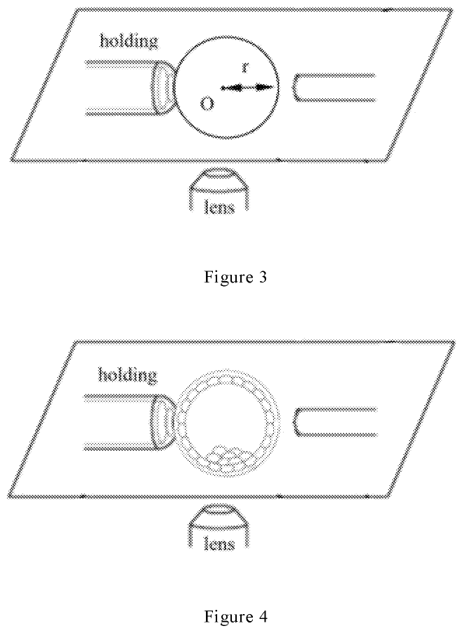

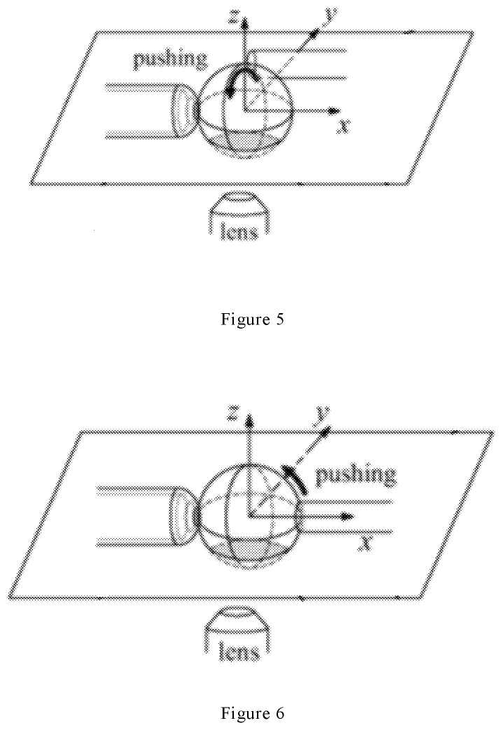

Particularly, the blastocyst is first fixed by a holding micropipette. The focal plane is adjusted to a middle plane of the blastocyst to acquire a first image as shown in FIG. 3. Then the focal plane is moved downward until each TE cell and ICM are clearly visible, as shown in FIG. 4. The current focal plane is fixed, to capture images during the subsequent rotation process of the blastocyst. Then, the blastocyst is gently pushed by using a biopsy micropipette. As shown in FIGS. 5 and 6, the blastocyst is rotated by a small angle a time, for example, less than 35°, More than 10 images are taken during the whole 360° rotation. The rotation angle does not need to be accurate as long as there is a certain overlap between two adjacent images. After each rotation, the blastocyst image at a current position will be taken. To avoid the interference of frequently capturing the images with the operations on the embryo, the whole rotation process is recorded by video, and then the multi-view image of each blastocyst is extracted from the video.

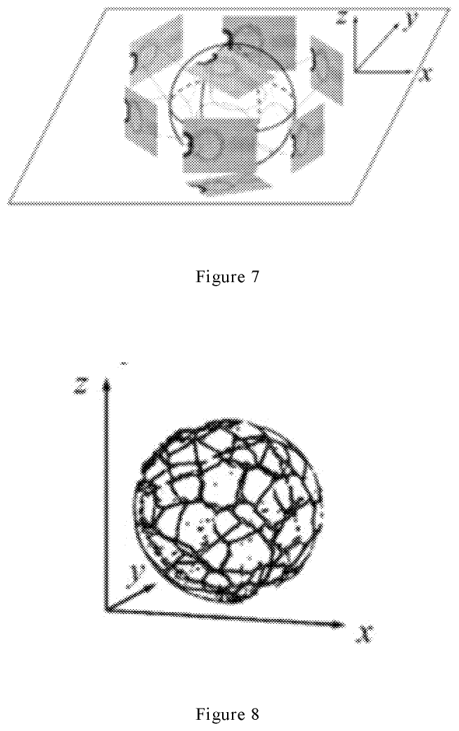

Then, a 3D surface model of the blastocyst is formed on a spherical surface. For 3D quantification of the morphology of the blastocyst, the center O and diameter of the blastocyst are measured from the image taken at the middle plane of the blastocyst as shown in FIG. 3, and used to construct a spherical surface Ω. Then all the multi-view images of the blastocyst are cropped into D×D centered on O. SR-SIFT algorithm is performed between multi-view images to calculate a transformation matrix thereof, and then image projection is performed, as shown in FIG. 7. On this basis, the multi-view image is projected on the spherical surface Ω to form a 3D surface model of the blastocyst, as shown in FIG. 8.

Finally, five accurate model input parameters including the blastocyst diameter, the TE cell quantity, the TE cell density, the standard deviation of the TE cell areas and the ICM area are acquired by 3D modeling of the blastocyst. After 3D modeling, the TE cells and ICM of the blastocyst are segmented by U-Net, and their morphological parameters are measured from the segmented 3D surface model. According to the current morphological grading system, the morphological parameters quantified in the present application include the blastocyst diameter, the TE cell quantity, the TE cell density, the standard deviation of the TE cell areas and the ICM area. The blastocyst diameter is used to quantify the blastocyst size. The TE cell quantity, density and size variance are used to quantify the morphological characteristics of TE cells, where the TE cell density is defined as TE cell quantity per 1000 μm². The ICM area is used to indicate the ICM size.

S202: Determine label information for each blastocyst in the data set by TE biopsy and PGT-A, to divide the blastocysts into euploid and aneuploid.

Exemplarily, after calculating the five parameters of each blastocyst, these five parameters are assigned to a group, and form a portion of data in the data set. Through the euploidy detection of each blastocyst, a label for a portion of data is obtained.

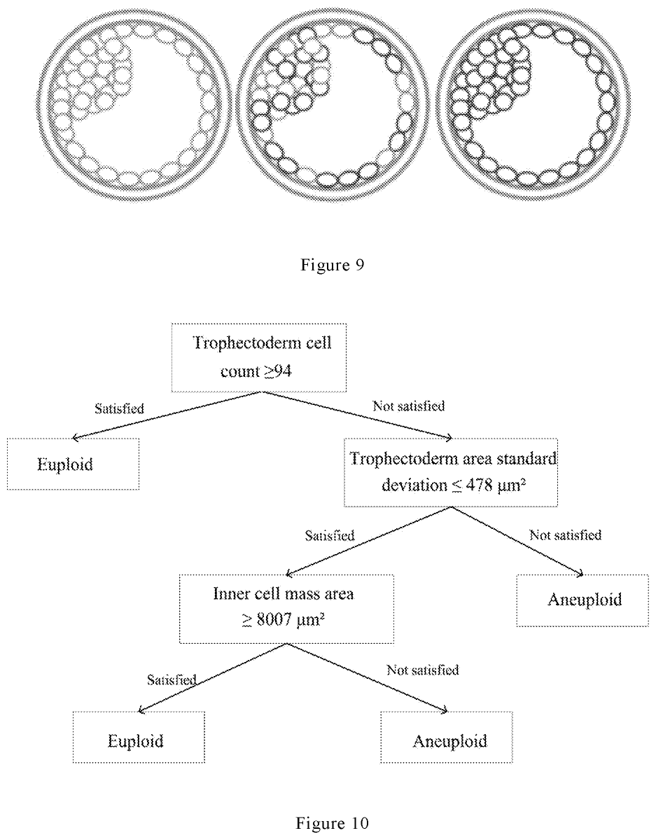

In a specific embodiment, a label for the data set is determined by TE biopsy and PGT-A. Exemplarily, TE biopsy is performed on the day 6 blastocyst immediately after the 3D modeling rotation. Laser pulse is used to create an opening of about 10 μm. 5-8 TE cells are sucked into a biopsy micropipette, and separated from the blastocyst by flicking poking. The biopsy sample is amplified and analyzed by new-generation sequencing (NGS, Illumina). As shown in FIG. 9, the proportion of abnormal cells gradually increases from left to right (that is, the dark cells in the figure), and the blastocysts are divided into euploid (abnormal cells account for <20%) and aneuploid (abnormal cells account for ≥20%). It is to be understood that the blastocysts are actually divided into three types by TE biopsy and PGT-A, including euploid, mosaic, or aneuploid. However, the label information for the data set in the present application is only divided into two categories, that is, euploid and aneuploid (the aneuploid in the present application refers to mosaic (abnormal cells account for 20%-80%) and aneuploid (abnormal cells account for >80%) in TE biopsy and PGT-A).

S203: Collect, according to the data set and the label information, a first target number of blastocysts, train an initial decision tree euploidy prediction model, and collect a second target number of blastocysts to form a test data set.

Exemplarily, S201-S202 are performed simultaneously to obtain the morphological parameters and label information of a single blastocyst, and information of multiple blastocysts is collected to formulate the training and test data set of the decision tree model for embryo euploidy prediction.

In a specific embodiment, the morphological parameters and label information of a single blastocyst are obtained through S201-S202, and the information of multiple blastocysts are collected to formulate the training and test data set of the decision tree model for embryo euploidy prediction.

A total of 226 day 6 blastocysts collected from 55 patients in the data set are used to train, validate and test the machine learning model. The mother as the patient is 21 to 44 years old (average 34.4 years, with the standard deviation being 5.2 years) and the father is 30 to 56 years old (average 39.7 years, with the standard deviation being 6.1 years). According to the results of PGT-A, among the 226 blastocysts in the data set, 56.6% (128/226) of the blastocysts are classified as euploid, and 43.3% (98/226) are classified as aneuploid, including mosaic (13.3%, 30/226) and aneuploid (30.1%, 68/226). 181 are used for model training and verification, and 45 are used as the test data set. In the test data set, 57.8% of the blastocysts are euploid, and 42.2% of the blastocysts are aneuploid.

S204: Test the trained decision tree euploidy prediction model by using the test data set until the accuracy of the test result reaches a preset threshold, so that the training of the decision tree euploidy prediction model is completed, and the target decision tree euploidy prediction model is obtained.

Exemplarily, after the decision tree euploidy prediction model is constructed, the model input includes: the blastocyst diameter, the TE cell quantity, the TE cell density, the standard deviation of the TE cell areas and the ICM area, and the model output includes euploid and aneuploid.

It is to be understood that the decision tree prediction model is used as the euploidy prediction model in the present invention, and all five parameters (blastocyst diameter, the TE cell quantity, the TE cell density, the standard deviation of the TE cell areas and the ICM area) determined by 3D morphological measurement are set as the model inputs for aneuploid prediction. When the model is trained, entropy is used to find the best segmentation at each node. To avoid over-fitting, the maximum depth of the tree is set to 3 and the minimum cost complexity pruning is used to reduce the complexity of the decision tree. The output of the trained model mainly includes euploid and aneuploid (including mosaic and aneuploid).

In some possible embodiments, the testing the trained decision tree euploidy prediction model by using the test data set comprises: performing univariate analysis and euploidy prediction on the blastocysts in the test data set.

In some possible embodiments, the univariate analysis comprises:
comparing the blastocyst diameters, the TE cell quantities, the TE cell densities, the standard deviations of the TE cell areas and the ICM areas of the euploid and aneuploid blastocysts; and
obtaining target values respectively corresponding to the blastocyst diameter, the TE cell quantity, the TE cell density, the standard deviation of the TE cell areas and the ICM area of the euploid blastocyst according to the comparison results.

Exemplarily, the univariate analysis is to analyze the difference of morphological parameters of different types. The univariate analysis is respectively performed on each of the five morphological parameters including the blastocyst diameter, the TE cell quantity, the TE cell density, the standard deviation of the TE cell areas and the ICM area. The blastocysts are further grouped according to the age, and whether there are differences in morphological parameters between the old group and the young group is analyzed.

In a specific embodiment, the univariate analysis is respectively performed on each of the five morphological parameters including the blastocyst diameter, the TE cell quantity, the TE cell density, the standard deviation of the TE cell areas and the ICM area. The blastocysts are further grouped according to the age, and whether there are differences in morphological parameters between the old group and the young group is analyzed.

The univariate analysis shows that there are significant differences in all the five morphological parameters between the euploid and aneuploid blastocysts. For the euploid blastocysts in the data set in the present application, the standard deviation of the TE cell areas is significantly lower (P<0.001, OR=0.992, 95% CI 0.989-0.994), the diameter is larger (P<0.001, OR=1.039, 95% CI 1.023-1.055), the TE cell quantity is higher (P<0.001, OR=1.067, 95% CI 1.050-1.084), the TE cell density is higher (P<0.001, OR=311.509, 95% CI 72.813-1332.710), and the ICM area is larger (P=0.002, OR=1.002, 95% CI 1.001-1.003). Table 1 specifically shows the univariate analysis of the correlation between the 3D morphological parameters and the euploidy.

TABLE 1

| | | | | Univariate analysis | |
|---|---|---|---|---|---|
| Morphological | | | | P | |
| parameter | All | Euploidy | Aneuploidy | value | OR (95% CI) |
| Diameter (μm) | 183.9 | 190.4 | 175.4 | <0.001 | 1.039 |
| (SD) | (21.6) | (19.1) | (21.8) | | (1.023-1.055) |
| TE cell | 110.0 | 141.3 | 69.0 | <0.001 | 1.067 |
| quantity (SD) | (49.7) | (38.7) | (27.9) | | (1.050-1.084) |
| TE cell density (cell | 1.1 | 1.3 | 0.8 | <0.001 | 311.509 |
| quantity/1000 μm²) | (0.4) | (0.3) | (0.3) | | (72.813-1332.710) |
| (SD) | | | | | |
| Cell size variance | 467.6 | 220.9 | 789.7 | <0.001 | 0.992 |
| (μm²) (SD) | (680.8) | (119.5) | (933.5) | | (0.989-0.994) |
| ICM area (μm²) | 5492.7 | 5901.1 | 4959.3 | 0.002 | 1.002 |
| (SD) | (2280.7) | (2303.2) | (2147.6) | | (1.001-1.003) |

The blastocysts are further grouped according to the age (maternal age: <35 years vs. ≥35 years; and paternal age: <40 years vs. ≥40 years), and whether there are differences in morphological parameters between the old group and the young group is analyzed. The cell quantity in the blastocyst from the advanced maternal group (≥35 years) is significantly lower than that of the corresponding young group, and the standard deviation of the TE cell areas is significantly higher than that of the corresponding young group (101.7 vs. 116.1, P=0.031; 577.5 μm2 vs. 386.4 μm2, P=0.037). The blastocyst diameter of the advanced paternal group (≥40 years) is obviously smaller than that of the corresponding young group, the TE cell quantity is lower, and the ICM area is smaller (178.1 μm vs. 186.8 μm, P=0.004; 97.6 vs. 116.4, P=0.007; 4912.9 μm2 vs. 5792.4 μm2, P=0.006). Compared with the corresponding young group, the euploidy rate of blastocysts in the two advanced age groups are significantly lower (45.8% vs. 64.6% for the maternal groups, P=0.005; and 37.7% vs. 66.4% for the paternal groups, P=0.044). However, in the euploid blastocysts, no statistically significant difference is found in any of the five morphological parameters between the advanced age group and the young group. The same phenomenon is also observed in the aneuploid blastocysts. Table 2 specifically shows the distribution of 3D morphological parameters of different age groups.

TABLE 2

| Morphological | Paternal age | | P | Paternal age | | P |
|---|---|---|---|---|---|---|
| parameter | <35 | ≥35 | value | <40 | ≥40 | value |
| Diameter (μm) (SD) | 185.7 | 181.4 | 0.145 | 186.8 | 178.1 | 0.004 |
| | (19.6) | (24.0) | | (22.6) | (18.3) | |
| TE cell quantity | 116.1 | 101.7 | 0.031 | 116.4 | 97.6 | 0.007 |
| (SD) | (46.1) | (53.2) | | (49.1) | (48.7) | |
| TE cell density (cell | 1.1 | 1.0 | 0.081 | 1.1 | 1.0 | 0.137 |
| quantity/1000 μm²) | (0.4) | (0.5) | | (0.4) | (0.5) | |
| (SD) | | | | | | |
| Cell size variance | 386.4 | 577.5 | 0.037 | 449.8 | 502.0 | 0.586 |
| (μm²) (SD) | (525.2) | (837.9) | | (682.4) | (680.9) | |
| ICM area (μm²) | 5590.0 | 5361.1 | 0.475 | 5792.4 | 4912.9 | 0.006 |
| (SD) | (1995.3) | (2623.5) | | (2319.7) | (2098.5) | |

Then, the euploidy prediction result is analyzed. The model manifestations including the sensitivity, specificity, precision, accuracy, and AUC index of the model are analyzed.

In some possible embodiments, the analysis of the euploidy prediction result comprises:
inputting the test data set into the trained decision tree euploidy prediction model; and
determining, according to the TE cell quantity, the standard deviation of the TE cell areas, and the ICM area, whether each blastocyst in the test data set is euploid.

In a specific embodiment, the results of aneuploidy prediction on the test data set in the set data in the present application show that the accuracy of the decision tree model for aneuploidy prediction in the present application is 95.6% (95% CI 84.9%-99.5%), and AUC is 0.978 (95% CI 0.882-0.999). The sensitivity, specificity and precision of the decision tree model are 96.2% (95% CI 80.4%-99.9%), 94.7% (95% CI 74.0%-99.9%) and 96.2% (95 CI 78.7%-99.4%) respectively, which shows that it is powerful in avoiding false positive or false negative results. Table 3 specifically shows the performance of the decision tree model for euploidy prediction.

TABLE 3

| Sensitivity | Specificity, | Precision | Accuracy | AUC |
|---|---|---|---|---|
| (95% CI) | (95% CI) | (95% CI) | (95% CI) | (95% CI) |
| 96.2% | 94.7% | 96.2% | 95.6% | 0.978 |
| (80.4%- | (74.0%- | (78.7%- | (84.9%- | (0.882- |
| 99.9%) | 99.9%) | 99.4%) | 99.5%) | 0.999) |

To further test the prediction performance of the decision tree model in different age groups, the test data set is further divided into old age groups (maternal age≥35 years; and paternal age≥40 years) and young age groups (maternal age<35 years; and paternal age<40 years). The decision tree model is used to predict, and the results show that there is no significant difference between different age groups (maternal age<35 years vs. ≥35 years, the accuracy P=0.344, and P-value of AUC is 0.211; and paternal age<40 years vs. ≥40 years, the accuracy of predicting euploid blastocysts is P=0.344, and P-value of AUC is 0.879). Table 4 below specifically shows the performance of the decision tree model for euploidy prediction in different maternal and paternal age groups.

TABLE 4

| | Paternal age | | P | Paternal age | | P |
|---|---|---|---|---|---|---|
| Index | <35 | ≥35 | value | <40 | ≥40 | value |
| Accuracy | 100% | 91.7% | 0.344 | 96.4% | 94.1% | 0.344 |
| (95% CI) | (83.89%- | (73.00%- | | (81.65%- | (71.31%- | |
| | 100.00%) | 98.97%) | | 99.91%) | 99.85%) | |
| AUC | 1.000 | 0.958 | 0.211 | 0.981 | 0.958 | 0.879 |
| (95% CI) | (0.839- | (0.789- | | (0.843- | (0.779- | |
| | 1.000) | 0.999) | | 1.000) | 1.000) | |

S102: Input the target parameters into the target decision tree euploidy prediction model, determine, according to the target parameters of the blastocyst to be predicted, whether the blastocyst to be predicted is euploid.

In some possible embodiments, the determining, according to the target parameters of the blastocyst to be predicted, whether the blastocyst to be predicted is euploid includes:
when the TE cell quantity of the blastocyst to be predicted is greater than or equal to a first target value, the blastocyst to be predicted is euploid.

In some possible embodiments, when the TE cell quantity of the blastocyst to be predicted is less than the first target value,
if the standard deviation of the TE cell areas of the blastocyst to be predicted is less than or equal to a second target value, and the ICM area of the blastocyst to be predicted is greater than or equal to a third target value, the blastocyst to be predicted is euploid.

Exemplarily, the features and thresholds used at each node of the tree are extracted from the model. The rules of quantification by the decision tree model (as shown in FIG. 10) for euploidy prediction are summarized as follows. If the TE cell quantity of the day 6 blastocyst is greater than or equal to 94, the blastocyst is predicted to be euploid. If the standard deviation of the TE cell areas of the blastocyst is less than or equal to 478 μm², and the ICM area is greater than or equal to 8007 μm², the blastocyst is predicted to be euploid.

In summary, through the 3D modeling of the blastocyst, the morphology of the blastocyst is measured, and five blastocyst parameters including the blastocyst diameter, the TE cell quantity, the TE cell density, the standard deviation of the TE cell areas, and the ICM area are acquired. Moreover, in the method, a measurement method for fine measurement of the blastocyst parameters is constructed by image projection and U-Net for model segmentation, which provides vital data support for the accuracy of aneuploidy prediction. Moreover, the euploidy prediction method provided in the present application is a non-invasive prediction method, by which the euploidy prediction can be realized only by acquiring the five blastocyst parameters including the blastocyst diameter, the TE cell quantity, the TE cell density, the standard deviation of the TE cell areas, and the ICM area by 3D modeling of the blastocyst after the decision tree model is trained, and inputting these parameters into the decision tree model.

It can be seen that the euploidy prediction method provided in the present application is not only simple to operate, but also has the characteristics of high efficiency, high accuracy and others. The blastocyst euploidy prediction model can automatically predict the blastocyst euploidy without manual intervention in the prediction process.

Further, the 3D modeling technique of the blastocyst provided in the present application is not limited to the 3D modeling of the blastocyst, but also suitable for the 3D modeling of any spheroid cells and embryos.

Based on the same inventive concept, an embodiment of the present application further provides a non-invasive euploidy prediction system corresponding to the non-invasive euploidy prediction method provided in the above embodiments. Since the principle of the system for solving the problems in the embodiment of the present application is similar to that of the method in the above embodiments of the present application, the implementation of the system can refer to the implementation of the method, and will not be repeated here.

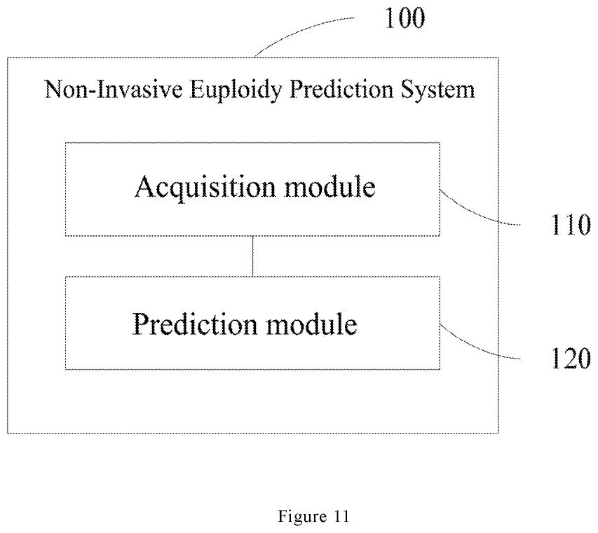

FIG. 11 shows function modules in a non-invasive euploidy prediction system 100 provided in an embodiment of the present application. As shown in FIG. 11, the non-invasive euploidy prediction system 100 includes:
an acquiring module 110, configured to acquire target parameters of a blastocyst to be predicted, where the target parameters include a blastocyst diameter, a TE cell quantity, a TE cell density, a standard deviation of the TE cell areas, and an ICM area of the blastocyst to be predicted; and
a prediction module 120, configured to input the target parameters into a target decision tree euploidy prediction model, and determine, according to the target parameters of the blastocyst to be predicted, whether the blastocyst to be predicted is euploid.

In some possible embodiments, the system further includes a model training module 121, configured to
acquire a data set, where the data set includes a blastocyst diameter, a TE cell quantity, a TE cell density, a standard deviation of the TE cell areas, and an ICM area of each of multiple blastocysts;
determine label information for each blastocyst in the data set by TE biopsy and PGT-A, to divide the blastocysts into euploid and aneuploid;
collect, according to the data set and the label information, a first target number of blastocysts, train an initial decision tree euploidy prediction model, and collect a second target number of blastocysts to form a test data set; and
test the trained decision tree euploidy prediction model by using the test data set until the accuracy of the test result reaches a preset threshold, so that the training of the decision tree euploidy prediction model is completed, and the target decision tree euploidy prediction model is obtained.

In summary, in the non-invasive euploidy prediction method and system provided in the embodiments of the present application, the target decision tree euploidy prediction model is obtained by acquiring multiple blastocyst images and their corresponding euploidy detection results, acquiring five blastocyst parameters including the blastocyst diameter, the TE cell quantity, the TE cell density, the standard deviation of the TE cell areas, and the ICM area and their corresponding euploidy results by 3D modeling of the blastocyst images and morphological measurement, and inputting them into a neural network for training. By inputting the five blastocyst parameters including the blastocyst diameter, the TE cell quantity, the TE cell density, the standard deviation of the TE cell areas and the ICM area (by 3D modeling with the blastocyst images and morphological measurement) into the prediction model, the euploidy prediction result of the blastocyst can be directly outputted.

The five accurate blastocyst parameters including the blastocyst diameter, the TE cell quantity, the TE cell density, the standard deviation of the TE cell areas, and the ICM area are acquired by 3D modeling of the blastocyst. By inputting these pieces of data into the decision tree embryo euploidy prediction model, the prediction of the embryo euploidy is realized, thereby promoting the selection or classification of embryos in conventional IVF-ET cycles.

A person skilled in the art should appreciate that embodiments of the present application provide a method and system. Therefore, the present application can be embodied the form of complete hardware, complete software, or software combined with hardware.

Apparently, the above-described embodiments are merely examples provided for clarity of description, and are not intended to limit the implementations of the present invention. Other variations or changes can be made by those skilled in the art based on the above description. The embodiments are not exhaustive herein. Obvious variations or changes derived therefrom also fall within the protection scope of the present invention.

What is claimed is:

1. A non-invasive euploidy prediction method, comprising:
acquiring target parameters of a blastocyst to be predicted, wherein the target parameters comprise a blastocyst diameter, a trophectoderm (TE) cell quantity, a TE cell density, a standard deviation of the TE cell areas, and an inner cell mass (ICM) area of the blastocyst to be predicted; and
inputting the target parameters into a target decision tree euploidy prediction model, and determining, according to the target parameters of the blastocyst to be predicted, whether the blastocyst to be predicted is euploid.

2. The non-invasive euploidy prediction method according to claim 1, wherein the determining, according to the target parameters of the blastocyst to be predicted, whether the blastocyst to be predicted is euploid comprises:
when the TE cell quantity of the blastocyst to be predicted is greater than or equal to a first target value, the blastocyst to be predicted is euploid.

3. The non-invasive euploidy prediction method according to claim 2, wherein when the TE cell quantity of the blastocyst to be predicted is less than the first target value,
if the standard deviation of the TE cell areas of the blastocyst to be predicted is less than or equal to a second target value, and the ICM area of the blastocyst to be predicted is greater than or equal to a third target value, the blastocyst to be predicted is euploid.

4. The non-invasive euploidy prediction method according to claim 1, before inputting the target parameters into the target decision tree euploidy prediction model, further comprising:
acquiring a data set, wherein the data set comprises a blastocyst diameter, a TE cell quantity, a TE cell density, a standard deviation of the TE cell areas, and an inner cell mass (ICM) area of each of multiple blastocysts;
determining label information for each blastocyst in the data set by TE biopsy and preimplantation genetic testing for aneuploidies (PGT-A), to divide the blastocysts into euploid and aneuploid;
collecting, according to the data set and the label information, a first target number of blastocysts, training an initial decision tree euploidy prediction model, and collecting a second target number of blastocysts to form a test data set; and
testing the trained decision tree euploidy prediction model by using the test data set, until the accuracy of the test result reaches a preset threshold, so that the training of the decision tree euploidy prediction model is completed, and the target decision tree euploidy prediction model is obtained.

5. The non-invasive euploidy prediction method according to claim 4, wherein the blastocyst diameter, the TE cell quantity, the TE cell density, the standard deviation of the TE cell areas and the ICM area of each blastocyst in the data set are acquired through steps of:
fixing a single blastocyst at a center of a visual field by a micromanipulator system, and rotating the blastocyst around different preset centers to capture images at preset angles;
projecting the images on a spherical surface, to form a 3D surface model of the blastocyst; and
determining, from the 3D surface model of the blastocyst, the blastocyst diameter, the TE cell quantity, the TE cell density, the standard deviation of the TE cell areas and the ICM area of the single blastocyst.

6. The non-invasive euploidy prediction method according to claim 4, wherein the testing the trained decision tree euploidy prediction model by using the test data set comprises: performing univariate analysis and euploidy prediction on the blastocysts in the test data set.

7. The non-invasive euploidy prediction method according to claim 6, wherein the univariate analysis comprises:
comparing the blastocyst diameters, the TE cell quantities, the TE cell densities, the standard deviations of the TE cell areas and the ICM areas of the euploid and aneuploid blastocysts; and
obtaining target values respectively corresponding to the blastocyst diameter, the TE cell quantity, the TE cell density, the standard deviation of the TE cell areas and the ICM area of the euploid blastocyst according to the comparison results.

8. The non-invasive euploidy prediction method according to claim 7, wherein the analysis of the euploidy prediction result comprises:
inputting the test data set into the trained decision tree euploidy prediction model; and
determining, according to the TE cell quantity, the standard deviation of the TE cell areas, and the ICM area, whether each blastocyst in the test data set is euploid.

9. A non-invasive euploidy prediction system, comprising:
an acquiring module, configured to acquire target parameters of a blastocyst to be predicted, wherein the target parameters comprise a blastocyst diameter, a TE cell quantity, a TE cell density, a standard deviation of the TE cell areas, and an ICM area of the blastocyst to be predicted; and
a prediction module, configured to input the target parameters into a target decision tree euploidy prediction model, and determining, according to the target parameters of the blastocyst to be predicted, whether the blastocyst to be predicted is euploid.

10. The non-invasive euploidy prediction system according to claim 9, further comprising a model training module, configured to
acquire a data set, wherein the data set comprises a blastocyst diameter, a TE cell quantity, a TE cell density, a standard deviation of the TE cell areas, and an ICM area of each of multiple blastocysts;
determine label information for each blastocyst in the data set by TE biopsy and PGT-A, to divide the blastocysts into euploid and aneuploid;
collect, according to the data set and the label information, a first target number of blastocysts, train an initial decision tree euploidy prediction model, and collect a second target number of blastocysts to form a test data set; and
test the trained decision tree euploidy prediction model by using the test data set until the accuracy of the test result reaches a preset threshold, so that the training of the decision tree euploidy prediction model is completed, and the target decision tree euploidy prediction model is obtained.
